(19) United States
(12) Patent Application Publication
(10) Pub. No.: US 2025/0140981 A1
(43) Pub. Date: May 1, 2025

(54) COOLING DEVICE FOR AN ELECTRIC BATTERY

(71) Applicant: HUTCHINSON, PARIS (FR)

(72) Inventors: Jean-Yves MOUNIER, PAUCOURT (FR); Nicola MORETTI, GASSINO TORINESE (IT); Franco VIROGLIO, CHIVASSO (IT)

(21) Appl. No.: 18/929,294

(22) Filed: Oct. 28, 2024

(30) Foreign Application Priority Data
Oct. 31, 2023 (FR) 2311874

(51) Int. Cl. H01M 10/6568; B60L 50/64; H01M 10/613; H01M 10/625; H01M 10/647; H01M 50/209

(52) U.S. Cl. CPC H01M 10/6568; H01M 10/613; H01M 10/625; H01M 10/647; H01M 50/209; B60L 50/64; H01M 2220/20

(57) ABSTRACT

A cooling device for an electric battery includes a casing formed from two sheets of flexible material which extend facing one another, the casing defining lateral edges, at least one fluid circulation channel extending between the sheets, and at least one inlet fluidic connector and at least one outlet fluidic connector. The cooling device also includes a rigid support structure having a first part and a second part shaped to clasp at least one of the lateral edges of the casing between them, the second part defining at least one hollowed-out portion intended to allow the casing to protrude from the support structure through said hollowed-out portion.

### CROSS REFERENCE TO RELATED APPLICATIONS

This application claims priority to French Patent Application No. 2311874 filed Oct. 31, 2023, hereby incorporated in its entirety.

### TECHNICAL FIELD

The invention relates to the technical field of electric batteries, and more precisely to the cooling of said batteries. Said batteries are for example installed in a vehicle having electric or hybrid propulsion.

In this respect, the invention relates to a cooling device for an electric battery. The invention also relates to an electric battery comprising such a cooling device.

### BACKGROUND

In an electric battery with cells, i.e. a battery comprising several independent battery elements grouped in an enclosure, the hottest elements are located in the center of the enclosure. As the elements are generally arranged so that their side faces are in contact with each other in order to reduce their overall size, the heat generated by these most hemmed-in elements is only discharged at their lower faces. The electrical connectors between these various battery elements are generally located on the upper faces, and are likely to give off significant heat as well. Indirect fluid cooling is the method most commonly used by manufacturers, because it is effective, fairly simple to set up, and inexpensive. This method consists of circulating a coolant (usually a water-glycol mixture) in a cooling device located under the battery elements. The fluid acts as a heat transfer fluid and draws heat energy from the battery in order to carry it away to outside the enclosure as it circulates.

As a result, the removal of heat is highly dependent on the thermal resistance in the exchange between the electrical connectors or the lower face of the battery elements, depending on the case, on the one hand, and the cooling device on the other hand.

In order to improve this thermal resistance, it is known to use thermal interface materials, such as thermally conductive resins, between the cold plate of the cooling device and the lower surfaces of the battery elements or the complex structures of the connectors, to fill in local gaps between these surfaces due to irregularities in these solid structures and their roughness. However, such a solution significantly increases the cost and mass of the battery. In addition, the thermal contact enabled by the use of such an interface material remains significantly less effective than a direct mechanical contact between conductive metal materials.

Another possibility for improving thermal contact is to use a flexible casing for the circulation of coolant instead of a rigid structure, this flexible casing deforming freely under the pressure from the circulating coolant and thus coming to fit snugly against the contours of the lower surface of the battery elements or electrical connectors, thereby providing good thermal contact.

The flexible casing is designed using two film sheets made of multiple materials and multiple layers, assembled by local welding so as to form one or more channels for the circulation of fluid. The two sheets may be separate or may be formed by a single sheet folded onto itself.

Such a casing thus makes it possible to have a cooling device benefiting from good thermal contact with the battery elements to be cooled, while being light and simple to manufacture compared to the rigid coolers of the prior art.

However, such a flexible casing does not provide sufficient mechanical resistance for placement above the battery cells or in a vertical or suspended position, due to its low mechanical strength. In addition, regions of the casing that are not positioned against a rigid element that exerts counter-pressure may become worn and deformed over the long term by the internal pressure from the flow of fluid.

SUMMARY

The invention aims to overcome these disadvantages, by proposing a cooling device for an electric battery which makes use of a flexible casing as described above that is appropriate for using it in a vertical or suspended position, as well for placing it in contact with elements to be cooled that are present on the upper, lower, and/or side faces of the battery elements. For this purpose, the invention relates to a cooling device for an electric battery, the cooling device comprising:
a casing formed from two sheets of flexible material which extend facing one another, the casing having weld regions where the sheets are secured to one another and separation regions where the sheets are able to extend at a distance from one another, the casing defining lateral edges,
at least one fluid circulation channel extending between the sheets through at least one of the separation regions, and
at least one inlet fluidic connector and at least one outlet fluidic connector of the casing, open to the at least one fluid circulation channel, characterized in that the cooling device further comprises:
a rigid support structure, the support structure comprising a first part and a second part as well as means for assembly of the second part and the first part, the second part and the first part being shaped to clasp at least one of the lateral edges of the casing between them, the second part defining at least one hollowed-out portion intended to provide an opening at at least one of the separation regions of the casing so as to allow the casing to protrude from the support structure through said hollowed-out portion.

Such a cooling device allows having satisfactory mechanical resistance and may thus be placed in a suspended and/or vertical position, while benefiting from the advantages of a flexible casing for the circulation of cooling fluid, particularly in terms of thermal contact.

The support structure is in particular arranged to clasp at least two lateral edges of the flexible casing, and more particularly two opposite lateral edges.

Advantageously, the support structure is arranged to clasp all the lateral edges of the flexible casing in order to hold the casing firmly in place and improve its fluidtightness.

The support structure may further comprise means of attachment, adapted to attach the support structure to a cover, a side wall, and/or a lower wall of an electric battery enclosure, and/or to battery elements of the electric battery, for example means of attachment by snap-fastening, by screwing, or hinged means.

Such a feature allows a simple assembly of the cooling device in a suspended position above the contacts of the battery elements, and also simplifies a possible disassembly of the device for maintenance.

The means of assembling the second part to the first part may be snap-fastening means of assembly comprising at least one tooth projecting from an edge of one among the second part and the first part and at least one corresponding indentation defined by the other among the second part and the first part.

Such a feature allows a simplified assembly of the cooling device, and its possible disassembly for maintenance or replacement of the flexible casing.

The first part may be closed off opposite each hollowed-out portion of the second part.

Such a feature allows applying counter-pressure on the casing at the fluid circulation channels, on the face which is not in contact with the elements to be cooled, in order to reduce deformations of the pouch over the long term.

The support structure may define a lateral edge arranged to be positioned along an outer contour of a set of battery elements of an electric battery.

Such a feature makes it possible to ensure and maintain the relative positions of the cooling device and the elements to be cooled, which allows reducing the risk of assembly errors or unwanted movement.

One among the second part and the first part may define at least one orifice arranged to allow one of the fluidic connectors connected to the casing to traverse it.

Such a feature improves the holding in place of the fluidic connectors which are thus fixed to the support structure.

Advantageously, the fluid connectors have a flared part positioned internally relative to the corresponding orifice and enabling the connector to be locked against the support structure.

The support structure may have a substantially rectangular shape, the hollowed-out portion of the second part extending along a path forming at least one round trip over an area of said rectangular shape.

Such a feature allows the connectors of the battery assembly to be cooled by using a single fluid circulation channel and thereby providing the cooling assembly with a simple geometry and good mechanical strength.

The hollowed-out portion of the second part may have a U-shape and the casing may comprise at least one circulation channel having a corresponding U-shape.

At least one among the second part and the first part may comprise at least one stiffening rib.

Such a feature allows improving the mechanical strength of the support structure against bending and buckling, thereby improving the durability of the cooling device. The support structure may be formed from plastic material, by molding.

Such a feature allows manufacturing the support structure simply, quickly, and inexpensively.

The plastic material is, for example, polypropylene (PP), polyamide (PA), polyethylene (PE), polyphenylene sulfide (PPS), polyoxymethylene (POM), or the like.

Optionally, the plastic material may be reinforced by adding glass fibers to the polymer matrix.

Alternatively, the support structure may be formed by an additive manufacturing process, or by stamping.

The invention also relates to an electric battery comprising:
a plurality of battery elements arranged in an enclosure, each battery element having elements to be cooled which are arranged on a lower, upper, or side face of the battery element, and
a cooling device as above,
the support structure being positioned to have each hollowed-out portion opposite the elements to be cooled, the flexible casing being arranged to come into contact with the elements to be cooled when a coolant is circulating in the at least one circulation channel.

### BRIEF DESCRIPTION OF THE FIGURES

FIG. 1 is an exploded perspective view of the main elements of an electric battery according to the invention,

FIG. 2 is an exploded perspective view of a cooling device for the battery of FIG. 1,

FIG. 3 is a cross-section view of the cooling device of FIG. 2,

FIG. 4 is a detailed perspective view showing means of assembling the cooling device of FIGS. 1 and 2,

FIG. 5 is a perspective view of a base of a fluidic connector of the cooling device of FIGS. 2 to 4,

FIG. 6 is a perspective view of the base of FIG. 5 when carrying an O-ring,

FIG. 7 is a perspective view of the fluidic connector of FIGS. 5 and 6, assembled, and

FIG. 8 is a cross-section view of the connector of FIGS. 5 to 7.

### DETAILED DESCRIPTION

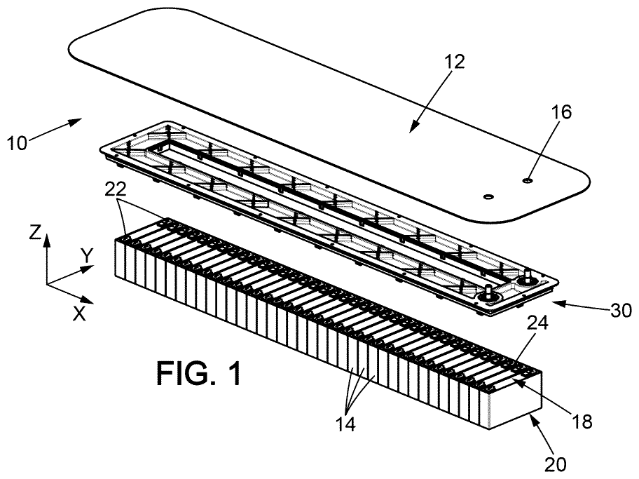

FIG. 1 shows an electric battery 10 intended for storing energy, intended in particular for applications on board a vehicle, for example a vehicle with electric or hybrid propulsion.

Said vehicle is for example a motor vehicle, a road or rail transport vehicle, a maritime vehicle, or some other vehicle.

Alternatively, battery 10 is intended for a fixed or mobile installation requiring a supply of electrical energy with no connection to the power grid or in addition to such a connection.

The battery comprises a closed, substantially sealed enclosure 12 (only the cover is shown in the figures, for clarity), and a plurality of battery elements 14, or cells, arranged in enclosure 12 and capable of storing electrical energy.

Enclosure 12 comprises a removable upper cover, partially represented in FIG. 1, which defines ports 16 intended for the supply of coolant.

Each battery element 14 has a general shape that is substantially parallelepiped and thus defines an upper face 18, a lower face 20, and four side faces.

The expressions “upper” and “lower” are understood here to be relative to a standard positioning of the battery in operating condition.

Battery elements 14 are arranged in alignment in at least one row extending in an alignment direction X. In addition, an elevation direction Z and a transverse direction Y are defined, both perpendicular to each other and perpendicular to alignment direction X, elevation direction Z being oriented substantially vertically in a standard operating orientation of battery 10.

Battery elements 14 may be arranged in contact with each other by their respective side faces, along alignment direction X, or with small gaps between two neighboring battery elements along alignment direction X.

Each battery element 14 comprises connectors 22 arranged on its upper face 18, one on either side of said upper face along transverse direction Y. Connectors 22 of the battery elements thus form two rows extending along alignment direction X.

Connectors 22 of battery elements 14 are connected to parallel bus-bars 24 which extend substantially along alignment direction X, allowing energy to be supplied to battery elements 14 for the storage or removal of energy from the battery elements in order to power an electrical device.

Battery 10, and more particularly battery elements 14, generate heat during operation and require cooling for optimal operation and in order to provide a satisfactory operating time and satisfactory safety.

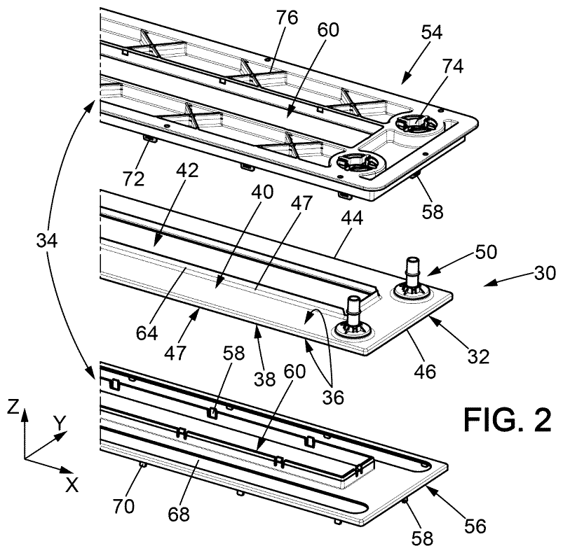

For this purpose, battery 10 comprises at least one cooling device 30 for the elements to be cooled in the battery, shown in more detail in FIGS. 2 to 4.

The elements to be cooled may be battery elements 14, and more specifically lower faces 20 or side faces of the battery elements, or connectors 22 of the battery elements as well as bus-bars 24, which are arranged above the upper faces of the battery elements.

In the example shown in the figures, cooling device 30 is thus arranged to cool connectors 22 of the battery elements, and bus bars 24, and is thus positioned in enclosure 12, suspended from the cover, above battery elements 14.

Cooling device 30 comprises a flexible casing 32 intended to accommodate the coolant, as well as a support structure 34 adapted to improve the rigidity and strength of cooling device 30.

Casing 32 is formed of two sheets 36 of flexible material extending facing one another and partially welded to one another.

Thus, casing 32 has weld regions 38 where sheets 36 are secured to each other, and separation regions 40 where sheets 36 are not welded to each other and are thus able to extend at a distance from each other, defining an internal space between them.

Weld regions 38 follow in particular an outer edge of casing 32, so as to seal off an internal space of casing 32.

Sheets 36 are formed from a multilayer film that is cut to obtain the desired geometry.

The film is for example a stack of layers as follows: a first layer of polyethylene terephthalate (PET), a layer of aluminum (Al), a second layer of polyethylene terephthalate, and a layer of polyethylene (PE). This type of film is commonly used in the food industry, for an advantageous insulation of products.

In the case of flexible casing 32, the aluminum layer provides very good thermal conductivity and reduces the risk of fluid permeating through the sheets, the layers of polyethylene terephthalate provide good resistance to temperature and to the ambient environment, and the polyethylene layer serves as an adhesive layer, for fixing the two sheets by fusing the two layers of polyethylene that are in contact with each other.

In the example shown, flexible casing 32 has a substantially rectangular shape and defines a rectangular central opening 42. The rectangular shape of casing 32 comprises, for example, two long sides 44 which extend in alignment direction X, and two short sides 46 which extend in transverse direction Y.

Casing 32 defines lateral edges 47, in particular external lateral edges 47 extending along the long sides and the short sides, as well as internal lateral edges 47 which run along central opening 42.

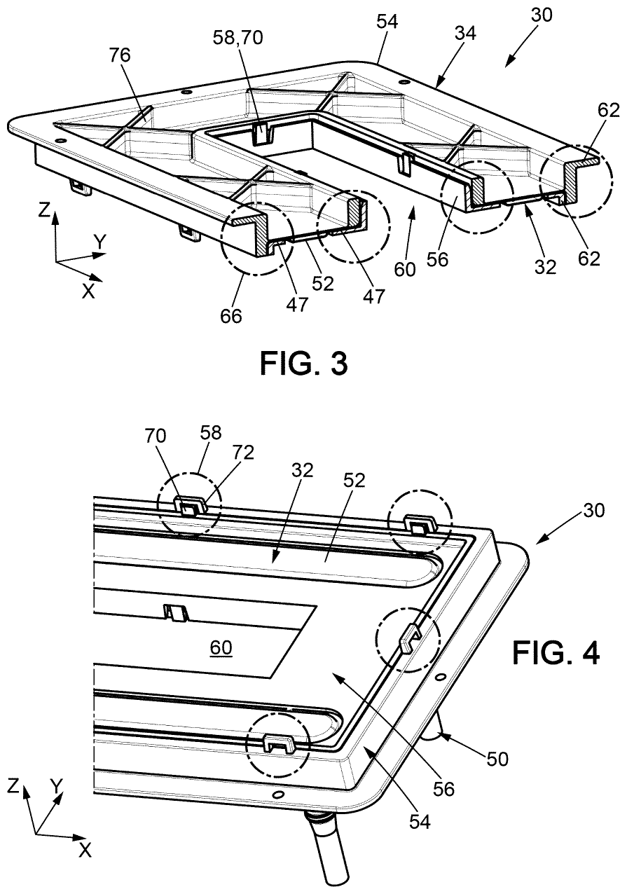

Cooling device 30 further comprises at least one inlet fluidic connector 50 and at least one outlet fluidic connector 50 which are arranged in the casing, and at least one fluid circulation channel 52, shown in FIGS. 3 and 4, extending between sheets 36 of the casing from the at least one inlet connector 50 to the at least one outlet connector 50.

Together, separation regions 40 of sheets 36 define said at least one fluid circulation channel 52 in the internal space.

In the example shown, inlet and outlet fluidic connectors 50 are positioned on the same side of the rectangular shape of casing 32.

For example, the two fluidic connectors 50 are positioned on the same short side 46 of the rectangular shape of casing 32, meaning at the same end of casing 32 along alignment direction X, one on either side of said rectangular shape along transverse direction Y.

In the example shown, casing 32 comprises a single fluid circulation channel 52 having a U shape, meaning that channel 52 extends from inlet connector 50 along one of long sides 44, then along short side 46 opposite connectors 50, and along the other of long sides 44 to the outlet connector.

More generally, channel 52 extends along a path forming at least one round trip on casing 32, in order to extend along the two rows of connectors 22 of battery elements 14 and allow a fluid connection of the inlet and the outlet at the same lateral edge 47 of casing 32.

Channel 52 may also extend along a path which winds along the extent of casing 32, i.e. forming at least one meander, which increases the cooled surface area.

Channel 52 may thus have a V shape, a W shape, etc.

Alternatively, casing 32 may comprise several channels 52 diverging from at least one inlet point and grouping back together at at least one outlet point.

In another alternative, casing 32 may comprise a plurality of channels 52 that are fluidly separate from each other.

In particular, casing 32 may comprise two substantially rectilinear and mutually parallel channels 52, extending along the two rows of connectors 22 and the bars 24, in alignment direction X.

According to the invention, cooling device 30 further comprises a rigid support structure 34 for flexible casing 32.

The expressions “rigid” and “flexible” are understood here to be relative to each other. In addition, the flexible nature of casing 32 implies that without external action, the casing deforms under the effect of its own weight, while the rigid nature of support structure 34 implies that it does not undergo any significant deformation under the effect of its own weight.

Support structure 34 comprises a first part 54 and a second part 56, as well as means 58 of assembling second part 56 and first part 54.

In the example considered, support structure 34 and casing 32 are intended to be arranged above battery elements 14.

First part 54 is therefore an upper part, arranged above second part 56 in elevation direction Z, second part 56 therefore being a lower part.

Second part 56 and first part 54 are shaped to clasp between them at least one of lateral edges 47 of casing 32, when they are assembled.

Thus, flexible casing 32 is held by its lateral edges 47, which are clasped by and supported between first and second parts 54, 56 of support structure 34.

First part 54 and second part 56 each have, for example, the shape of a flat rectangular frame extending perpendicularly to elevation direction Z, defining a central opening 60, first part 54 and second part 56 thus having respective external edges and internal edges.

Advantageously, first part 54 and second part 56 comprise flanges 62 which extend along external lateral edges and/or internal lateral edges, projecting in elevation direction Z.

Advantageously, flexible casing 32 may comprise flaps 64 extending along internal lateral edges 47 of casing 32 and running along central opening 42, these flaps 64 being held between flanges 62 of the first and second parts of support structure 34. This further improves the retention of the flexible casing between the two parts.

Advantageously, flanges 62 extending along the external lateral edges of first part 54 and second part 56 cooperate to form an external lateral flange 66 of support structure 34, arranged to be positioned along an outside edge of the set of battery elements 14, so as to simplify the installation of the cooling device and prevent its movement.

Second part 56 defines at least one hollowed-out portion 68 intended to provide an opening at at least one of separation regions 40 of casing 32, to allow casing 32 to protrude from support structure 34 through hollowed-out portion 68.

Each hollowed-out portion 68 has a shape identical to that of one of fluid circulation channels 52. Thus, in the example shown, there is one hollowed-out portion 68 which has a U-shape identical to that of fluid circulation channel 52 of casing 32.

This allows casing 32 to project through hollowed-out portion 68 along the entire extent of channel 52, in order to reach the elements to be cooled.

Each hollowed-out portion 68 has for example a substantially constant width along its length, measured transversely to the local direction of elongation of hollowed-out portion 68 and of coolant channel 52.

First part 54 is advantageously closed off opposite each hollowed-out portion 68 of second part 56. This allows maintaining backpressure on flexible casing 32, to prevent it from extending in an undesired direction.

Means 58 of assembling second part 56 to first part 54 are for example snap-fastening means of assembly comprising at least one tooth 70 projecting from an edge of one among the second part and first part and at least one corresponding indentation 72 defined by the other among the second part and the first part.

For example, means 58 of assembly comprise indentations 72 distributed along the inner rim and outer rim of first part 54, and corresponding teeth 70 distributed along the inner rim and outer rim of second part 56.

Advantageously, support structure 34 further comprises means of attachment, adapted to fix support structure 34 to the cover of electric battery enclosure 12.

The means of assembly are for example positioned on first part 54, along the outer rim.

The means of attachment for support structure 34 may additionally or alternatively be adapted to fix support structure 34 to a side or bottom wall of enclosure 12.

The means of attachment for support structure 34 may additionally or alternatively be adapted to fix support structure 34 to battery elements 14, in particular to bottom 20, side, or top 18 faces of battery elements 14.

The means of attachment for support structure 34 are for example means of attachment by snap-fastening, by screwing, or hinged means.

First part 54 defines at least one orifice 74 arranged to allow the passage of each fluidic connector 50 connected to casing 32. In the example shown, which has two connectors 50, first part 54 defines two orifices 74.

Orifices 74 are for example substantially circular, and are coincident with corresponding ports 16 defined in enclosure 12, in particular in the cover of enclosure 12.

Alternatively, at least one of orifices 74 is defined by second part 56, according to the configuration of connectors 50.

Advantageously, first part 54 comprises at least one stiffening rib 76, capable of improving the bending stiffness of support structure 34.

Ribs 76 extend for example along elevation direction Z, advantageously from the outer rim to the inner rim of first part 54.

In the example shown, first part 54 comprises a plurality of such ribs 76, forming crosspieces.

Support structure 34 is formed from plastic material, in particular by separately molding first part 54 and second part 56.

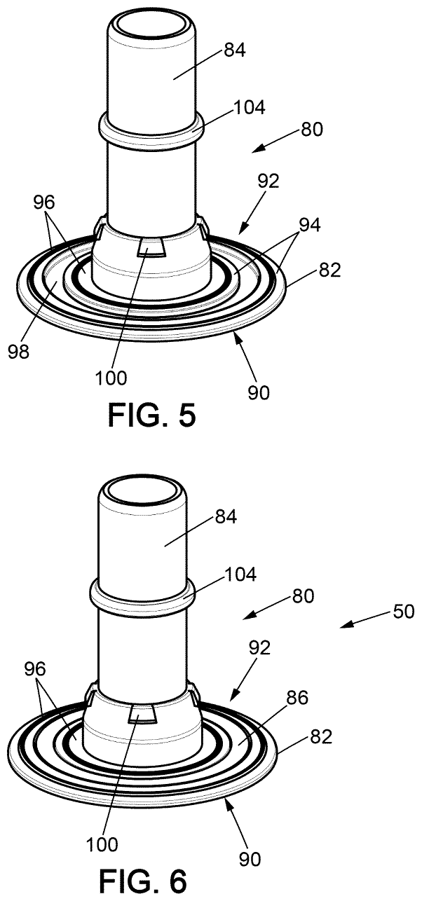

Alternatively, support structure 34 may be formed by stamping or by additive manufacturing. Inlet and outlet fluidic connectors 50 are for example of the type shown in FIGS. 5 to 8.

Fluidic connectors 50 are arranged in respective inlet or outlet orifices made in sheets 36 forming casing 32.

Each fluidic connector 50 comprises a base 80 formed by a base plate 82 arranged internally relative to sheet 36 and a tube 84 secured to base plate 82 and extending through the orifice of sheet 36.

Base plate 82 is substantially perpendicular to the elevation direction in the example shown, while tube 84 extends substantially along elevation direction Z.

Each fluidic connector 50 further comprises a ring 88 assembled to base 80, resting against an outer surface of sheet 36.

Advantageously, each fluidic connector 50 further comprises at least one O-ring 86, arranged between base plate 82 of base 80 and the inner face of sheet 36.

In this case, ring 88 compresses the sheet and said O-ring(s) 86 against base 80.

Base plate 82 defines a central through-opening 90 through which the mouth of tube 84 leads into the internal space of flexible casing 32.

For example, base plate 82 has a general disk shape, concentric with central opening 90.

Base plate 82 further defines an upper face 92 by which connector 50 is fixed to the inner face of sheet 36, by a weld circumferentially surrounding tube 84 and extending around the orifice.

For example, connector 50 comprises for this purpose at least one rib 94 defined on base plate 82, circumferentially surrounding tube 84, and in particular at least two ribs 94 radially spaced apart from each other relative to tube 84.

Ribs 94 protrude from base plate 82 to a ridge line 96, by which they are fixed to the inner face of sheet 36.

The fixing of ribs 94 to sheet 36 is for example carried out by thermal welding of ridge line 96 to the internal polyethylene layer of sheet 36.

Ribs 94 are for example substantially circular and concentric.

Advantageously, ribs 94 define between them at least one groove 98 for receiving O-ring 86.

In the example shown, base 80 defines two such ribs 94, which allow having two weld lines for welding to sheet 36 and having a single O-ring 86 arranged in groove 98 formed between the two ribs 94.

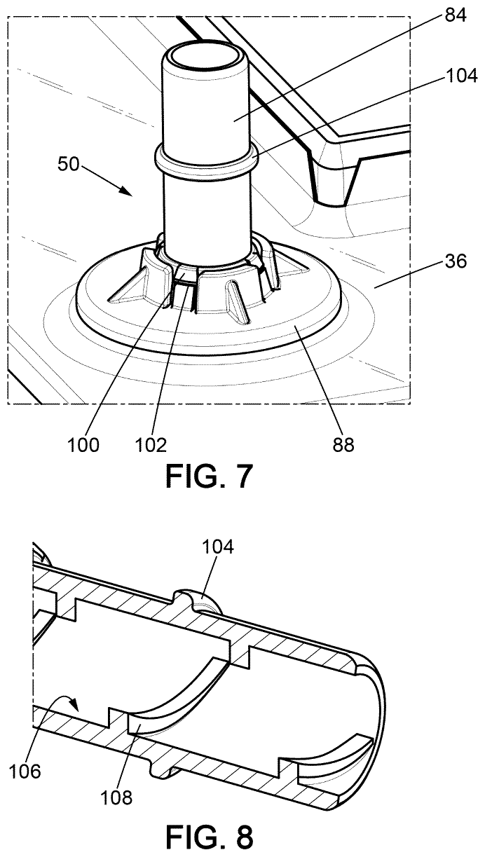

Ring 88, shown in FIG. 7, is assembled to the base, for example by screwing or snap-fastening, and circumferentially surrounds tube 84.

In the example shown, tube 84 defines on its outer surface a plurality of teeth 100 regularly distributed around its circumference and which project radially from tube 84, while ring 88 defines a same number of corresponding indentations 102, shaped to receive teeth 100 by snap-fastening when ring 88 is fixed to base 80.

Alternatively, an outer surface of tube 84 may define a thread and an inner surface of ring 88 may define a complementary thread, said threads making it possible to fix ring 88 to base 80 by screwing.

Thus, ring 88 is arranged to rest against an outer face of sheet 36 and exerts force on O-ring 86 through the sheet, which allows having a reinforced seal in addition to the weld lines at ribs 94.

Tube 84 may also define a peripheral rib 104 for fixing a coolant conveyance pipe, which extends at a distance from ring 88, at the side away from base plate 82.

Advantageously, as shown in FIG. 8, an inner surface 106 of tube 84 has reliefs 108 arranged to generate turbulence in a flow of fluid through tube 84.

Said reliefs 108 have, for example, the shape of ramps extending over inner surface 106 of tube 84 in a direction transverse to the local direction of elongation of tube 84, protruding towards the interior of tube 84.

Such reliefs 108 allow improved mixing of the fluid flowing through tube 84 and allow avoiding the formation of a stagnant layer of fluid along inner surface 106, which would reduce the heat transfer efficiency.

Alternatively, other types of fluidic connectors may be envisaged, depending on the position of cooling device 30 in enclosure 10, and depending on the angle of access to connectors 50 for the coolant delivery pipes.

For example, the connectors may extend substantially along alignment direction X.

1. A cooling device (30) for an electric battery (10), the cooling device (30) comprising:
a casing (32) formed from two sheets (36) of flexible material which extend facing one another, the casing (32) having weld regions (38) where the sheets (36) are secured to one another and separation regions (40) where the sheets (36) are able to extend at a distance from one another, the casing (32) defining lateral edges (47),
at least one fluid circulation channel (52) extending between the sheets (36) through at least one of the separation regions (40), and
at least one inlet fluidic connector (50) and at least one outlet fluidic connector (50) of the casing (32), open to the at least one fluid circulation channel (52),
characterized in that the cooling device (30) further comprises:
a rigid support structure (34), the support structure (34) comprising a first part (54) and a second part (56) as well as means for assembly (58) of the second part (56) and the first part (54), the second part (56) and the first part (54) being shaped to clasp at least one of the lateral edges (47) of the casing (32) between them, the second part (56) defining at least hollowed-out portion (68) intended to provide an opening at at least one of the separation regions (40) of the casing (32) so as to allow the casing (32) to protrude from the support structure (34) through said hollowed-out portion (68).

2. The cooling device (30) according to claim 1, wherein the support structure (34) further comprises means of attachment adapted to attach the support structure (34) to a cover, a side wall, and/or a lower wall of an enclosure (12) of an electric battery (10), and/or to battery elements (14) of the electric battery (10), for example means of attachment by snap-fastening, by screwing, or hinged means.

3. The cooling device (30) according to claim 1, wherein the means of assembling (58) the second part (56) to the first part (54) are snap-fastening means of assembly comprising at least one tooth (70) projecting from an edge of one among the second part (56) and the first part (54) and at least one corresponding indentation (72) defined by the other among the second part (56) and the first part (54).

4. The cooling device according to claim 1, wherein the first part (54) is closed off opposite each hollowed-out portion (68) of the second part (56).

5. The cooling device according to claim 1, wherein the support structure (34) defines a lateral edge (66) arranged to be positioned along an outer contour of a set of battery elements (14) of an electric battery (10).

6. The cooling device according to claim 1, wherein one among the second part (56) and the first part (54) defines at least one orifice (74) arranged to allow one of the fluidic connectors (50) connected to the casing (32) to traverse it.

7. The cooling device according to claim 1, wherein the support structure (34) has a substantially rectangular shape, the hollowed-out portion (68) of the second part (56) extending along a path forming at least one round trip over an area of said rectangular shape.

8. The cooling device according to claim 1, wherein at least one among the second part (56) and the first part (54) comprises at least one stiffening rib (74).

9. The cooling device according to claim 1, wherein the support structure (34) is formed from plastic material, by molding.

10. Electric battery (10) comprising:
a plurality of battery elements (14) arranged in an enclosure (12), each battery element (14) having elements to be cooled (22, 24) which are arranged on an upper (18), lower (20), or side face of the battery element (14), and
the cooling device (30) according to claim 1,
the support structure (34) being positioned to have each hollowed-out portion (68) opposite the elements to be cooled (22, 24), the flexible casing (32) being arranged to come into contact with the elements to be cooled (22, 24) when a coolant is circulating in the at least one circulation channel (52).
